(19) United States
(12) Patent Application Publication
(10) Pub. No.: US 2012/0241637 A1
(43) Pub. Date: Sep. 27, 2012

(54) Scintillators And Subterranean Detectors

(76) Inventors: John J. Simonetti, Hamilton, NJ (US); Donna Simonetti, Hamilton, NJ (US); Albert Hort, Mount Laurel, NJ (US)

(21) Appl. No.: 13/320,561

(22) PCT Filed: May 18, 2010
(86) PCT No.: PCT/US10/35221

§ 371 Date: Apr. 12, 2012

Related U.S. Application Data
(60) Provisional application No. 61/179,911, filed on May 20, 2009.

(51) Int. Cl. G01T 3/06

(52) U.S. Cl. 250/390.11

(57) ABSTRACT

The present disclosure provides a protective scintillator package for enclosing a scintillator wherein at least one component in the package is at least partially formed from a viscoelastic material. The protective package may comprise both elastic and viscoelastic materials, which may both be included in one component or may be in differing components. The present disclosure further provides radiation detectors using such scintillator packages, as well as logging tools, and methods for oil exploration.

### RELATED APPLICATIONS

The present application claims priority to U.S. Provisional Patent Application Ser. No. 61/179,911 filed May 20, 2009.

### BACKGROUND

Many useful scintillator materials, including NaI(Tl), LaBr₃, and the like, require protection from various environmental stresses before they can be assembled into a radiation detector. This is particularly true if the scintillation detector is applied to well logging, or other subterranean use, which may expose the scintillator crystal to high temperatures and pressures, or mechanical shock and vibration. For many scintillators, this includes protection from direct exposure to air by enclosing the scintillator in a hermetically sealed container as described in U.S. Pat. No. 4,764,677. The use of regular elastic materials is also well known for this application as described in U.S. Pat. No. 4,158,773.

A typical sealed scintillator package assembly is shown in FIG. 1. A scintillator crystal 101 is wrapped or otherwise surrounded by one or more layers of a preferably diffuse reflector 106 sheet that is preferably formed from a fluorocarbon polymer. A permanently sealed scintillator package 100 may consist of a tubular metal housing 102 that has a sealed optical window 104 attached to one end. Window material may be sapphire that is hermetically brazed to a metal sleeve which can then be welded to the tubular housing 102. An appropriate glass window may alternatively be employed. This technology is known to those skilled in the art. The wrapped crystal 101 can be inserted in the hermetically sealed housing 102 which may already have the optical window 104 attached. The window 104 may be sapphire or glass, as noted in U.S. Pat. No. 4,360,733. The housing 102 may then be filled with a silicone (RTV) that fills the space between the crystal 101 and the inside diameter of the housing 104. Optical contact between the scintillator crystal 101 and the window 104 of the housing 102 is established using an internal optical coupling pad 108 comprising a transparent silicone rubber disk. A wave spring 110 and pressure plate 112 hermetically seal the end opposite the window 104.

### BRIEF DESCRIPTION OF THE DRAWINGS

FIG. 1 is a block diagram of a hermetically packaged scintillator.

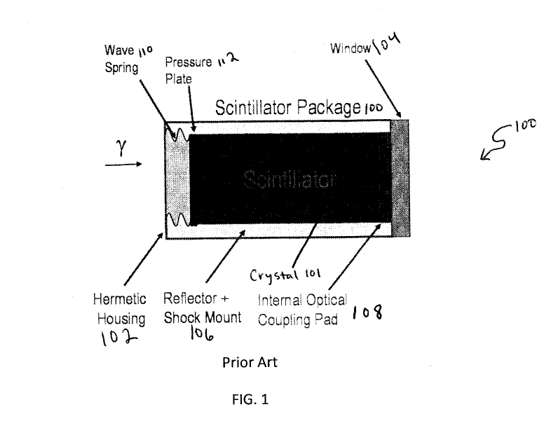

FIG. 2 is a diagram of a hermetically packaged scintillator of the invention.

FIG. 3 is a diagram of a scintillation detector of the invention wherein the scintillator and the corresponding photomultiplier are protected against shock using viscoelastic materials.

### DETAILED DESCRIPTION

In the following description, numerous details are set forth to provide an understanding of the present disclosure. However, it will be understood by those skilled in the art that the present invention may be practiced without these details and that numerous variations or modifications from the described embodiments are possible.

As used herein, these terms have the following meanings:

The terms viscoelastic and viscoelasticity refer to the property of materials that exhibit both viscous and elastic characteristics when a stress is applied. Elastic materials deform instantaneously when stress is applied and they return to the original state (shape) when the stress is removed. Viscoelastic materials have elements of both viscous and elastic properties. Elastic deformation is the result of a change in the length of bonds in a crystalline structure. However, the atoms do not change their position in the lattice. Therefore, when stress is released they return the bonds return to their original length with all the atoms in the same place. Viscoelasticity is the result of a change in the relative position of atoms or molecules in a material when stress is being applied. As a consequence, the change in shape associated with the application of a stress is at least partially permanent, i.e., the material exhibits hysteresis. Such a deformation is desirable if one intends to convert mechanical energy (e.g. from shock and vibration) into another form (typically heat) and therefore reduce the impact of mechanical stresses. Since the material dissipates mechanical energy, it acts as a shock absorber. If the deformation is elastic the mechanical energy is only transformed from kinetic to potential energy and then back as the stress is released.

The terms plastomer, and plastomers refer to a new generation of high-performance polymers, characterized by their narrow composition distribution and narrow molecular weight distribution. This makes them extremely tough and exceptionally clear and gives them good sealability.

The terms “component”, “element”, and “structure” are used interchangeably herein.

Scintillator based radiation detectors are applied for analysis of the formation surrounding a borehole in the oilfield. The scintillator component is subjected to extreme mechanical forces in this environment, necessitating protection. Protection serves not only to prevent physical damage to the scintillator but also to improve the quality of the measurement. A novel method for protecting the scintillator from shock will be described herein.

Some useful scintillation materials applied to borehole analysis include NaI(Tl), CsI(Tl), CsI(Na), LaBr₃:Ce, LaCl₃:Ce, BGO, GSO:Ce, (LuAlO3)LuAP:Ce, (Lu₃Al₅O₁₂)LuAG:Pr, LuYAP:Ce, and (YAlO₃)YAP:Ce. The first five materials require hermetic packaging to protect them from air and the humidity that air contains. All of the materials noted are susceptible to mechanical shock. Some provision is needed for protecting the scintillator from the adverse effects of shock and vibration. In the prior art, a simple elastomer layer is imposed between the scintillator and the inside walls of the housing. The covering provides a means to distribute the shock load but does little to dissipate the energy associated with the mechanical accelerations. As disclosed here, a component to the covering preferably also includes a viscoelastic element.

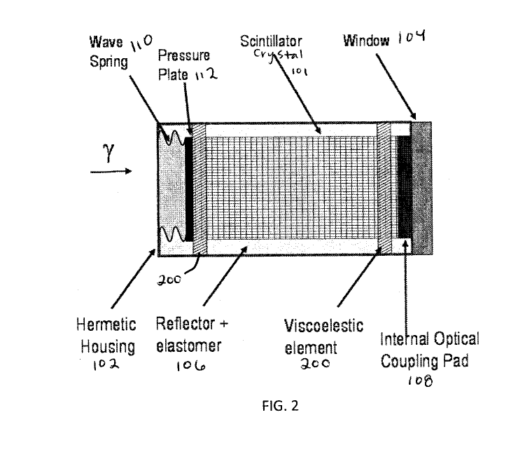

In one embodiment illustrated in FIG. 2, the viscoelastic element or structure is provided as discrete rings 200 surrounding the scintillator 101 in two locations along the length of the scintillator. The elastomer or plastomer rings 200 may be formed from one or more high temperature polymer(s) such as a perfluorelastomer. Useful viscoelastic polymers may include Viton® or Kalrez® fluoroelastomers, available from E.I DuPont de Nemours, or the like of a cellular silicone compound with appropriate viscoelastic properties. Viton® fluoroelastomers are categorized under the ASTM D1418 & ISO 1629 designation of FKM. This class of elastomers is a family comprising copolymers of hexafluoropropylen hexafluoropropylene (HFP) and vinylidene fluoride (VDF or VF2), terpolymers of tetrafluoroethylene (TFE), vinylidene fluoride (VDF) and hexafluoropropylene (HFP) as well as perfluoromethylvinylether (PMVE) containing specialties. The fluorine content of the most common Viton® grades varies between 66 and 70%.

The viscoelastic support ring elements may have a round or square cross section. While only two viscoelastic components are shown in the diagram of FIG. 2, the present invention does contemplate additional viscoelastic components to support or surround the scintillator. The viscoelastic material and elastic material may also be applied in sheet form to essentially wrap the cylindrical scintillator.

FIG. 2 shows a discrete component as being viscoelastic to demonstrate that both elastic and viscoelastic properties are material in scintillator package construction. In an embodiment, it is possible to incorporate a viscoelastic phase into the scintillator covering so that the medium is substantially continuous. The elastic component could be an RTV silicone that is initially a one or two part liquid. Silicones of this type include SYLGARD™ 184 or SYLGARD™ 186, available from Dow Corning Corporation, or similar compositions available from Shin-Etsu Silicones, Rhodia Group, and Wacker Chemie. Another useful silicone composition is Gelest “PP2-OE41”, available from Gelest, Inc., which is one preferred embodiment. The liquid phase may be filled with an appropriate volume of viscoelastic polymer in the form of small pieces. Once the viscoelastic polymer is dispersed in the liquid RTV, the mixture is processed into a solid by careful heating or allowing curing for a long period at room temperature as may be appropriate for the specific compound.

In still another embodiment, the viscoelastic element may also consist of a plastomer, such as polyethylenepropylene copolymer that is cross linked to exhibit viscoelastic properties in the temperature range of interest. Even though maximum operating temperatures may exceed the normal operating point of the viscoelastic material, the hermetic package used to house the scintillator will also provide some protection of the internal packaging elements from oxidative degradation of the viscoelastic component.

In any of the embodiments discussed, the viscoelastic element or component can be used alone, i.e., without an elastic covering, if the viscoelastic compound/composition is capable of maintaining scintillator alignment with the optical window of the hermetic housing. The disadvantage of using the viscoelastic element without an elastic covering is that such configurations limit the selection of materials to those with stable elastic and damping (viscoelastic) properties over the desired operating temperature range. Combining the properties of different materials offers a greater opportunity to optimize the scintillator support system to optimize immunity from mechanically induced degradation, as would be the case for combining of more rigid materials with viscoelastic materials like polyetheretherketone (PEEK), polycarbonate, polyester, polyimides or polycarbonates. All have viscoelastic properties, but over different ranges of temperature.

Once an appropriate mechanical support system is defined, the potted scintillator and attached rings can then be inserted into the tubular metal housing and sealed by fusion welding or brazing as is known by those familiar with the art.

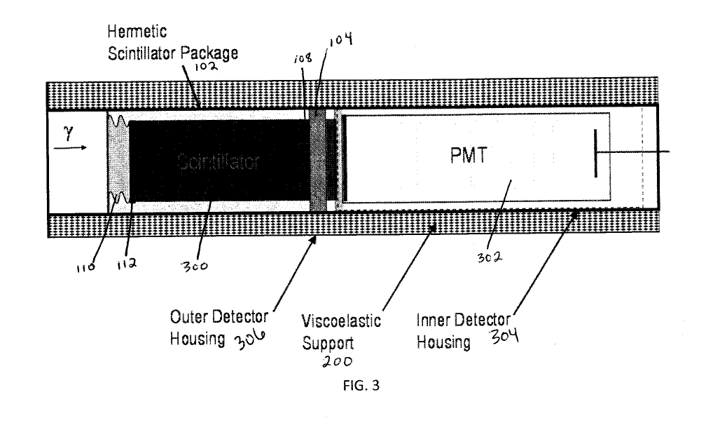

In another embodiment, the viscoelastic material or structure may be applied outside the confines of the hermetic scintillator package. This would, inter alia, allow for the use of viscoelastic materials that may not be chemically compatible with the scintillator materials. This configuration is shown schematically in FIG. 3. When the scintillator package and photodetector are assembled in a common inner housing 304, alignment of the components is assured, so as to form the nuclear detector. The inner housing 304 would then be placed into an outer housing 306 that has an inside diameter that is substantially larger than the inner housing 304. The viscoelastic support elements 308 (or alternatively dispersed viscoelastic support medium) could be applied to the annular space between the inner housing 304 and outer housing 306. Application of the viscoelastic elements 308 applied in the annular space between inner housing 304 and outer housing 306 would provide for the application of viscoelastic materials that are not rigid and have gelatinous properties. Materials such as Dow Corning's Sylgard™ 527 gel, “Q2-6635”, “Q2-6575” and ShinEtsu Sifel™ silicones may be applied in this way. The materials may be applied as a precast form or cast in place between the inner housing 304 and outer housing 306.

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A scintillator comprising a scintillation crystal, and a protective package provided to the scintillation crystal, wherein the protective package protects against at least one of mechanical shock, vibration, and oxidative degradation, said protective package comprising at least one element formed from a viscoelastic material.

2. A scintillator according to claim 1, the protective package further comprising one or more components or structures formed from an elastic or a viscoelastic material or a combination thereof.

3. A scintillator according to claim 2, wherein the protective package comprises both elastic and viscoelastic materials, which may both be included in one component or may be in differing components.

4. A scintillator according to claim 1, where the scintillator crystal is surrounded on at least one side and on one end by elastic materials and the scintillator crystal is supported by viscoelastic materials.

5. The scintillator of claim 4 wherein the viscoelastic material is provided as two or more rings around the scintillator crystal in at least two different axial positions.

6. The scintillator of claim 1, wherein the viscoelastic material is provided as at least three ribs in an axial direction of the scintillator crystal, thereby supporting the scintillator crystal at at least three different azimuths.

7. The scintillator of claim 1, wherein the viscoelastic material provides shock absorption selected from axial shock absorption and radial shock absorption or both.

8. The scintillator of claim 1, where the viscoelastic material is provided as a helix about the scintillator crystal.

9. The scintillator of claim 1, where protective package comprises a plurality of support elements comprising rings and ribs.

10. The scintillator of claims 1, wherein the viscoelastic material comprises a fluoroelastomer or a cellular silicone.

11. The scintillator of claim 1, where the scintillator crystal is at least partially surrounded by a cellular silicone.

12. The scintillator of claim 11, wherein the scintillator crystal is substantially fully surrounded by a cellular silicone.

13. The scintillator of claim 1, wherein the scintillation crystal is selected from the group comprising NaI(Tl), LaBr₃:Ce and LaCl₃:Ce, La-halides and La-mixed halides.

14. A radiation detector comprising;
a scintillator crystal operatively coupled to a photomultiplier in an inner housing, wherein the inner housing is substantially surrounded by a viscoelastic element.

15. The radiation detector of claim 14, wherein the viscoelastic material comprises two or more rings around the scintillator crystal in at least two different axial positions.

16. The radiation detector of claim 14, wherein the viscoelastic material comprises at least three ribs in an axial direction relative to the scintillator crystal supporting the scintillator crystal at at least three different azimuths.

17. The radiation detector of claim 14, wherein the viscoelastic material comprises a helix about the scintillator crystal.

18. The radiation detector of claim 14, wherein the viscoelastic material comprises a combination of rings and ribs.

19. The radiation detector of claim 14, wherein the viscoelastic material comprises a fluoroelastomer or a cellular silicone.

20. The radiation detector of claim 14, wherein the scintillator crystal is surrounded at least partially by a cellular silicone.

21. The radiation detector of claim 20, wherein the scintillator crystal is substantially fully surrounded by a cellular silicone.

22. The radiation detector of claim 14, wherein the inner housing is mounted in a viscoelastic material.

23. The radiation detector of claim 14, wherein the scintillation crystal is selected from the group comprising NaI(Tl), LaBr₃:Ce and LaCl₃:Ce, La-halides and La-mixed halides.
